(19) United States
(12) Patent Application Publication
(10) Pub. No.: US 2008/0046918 A1
(43) Pub. Date: Feb. 21, 2008

(54) METHOD AND SYSTEM FOR CALCULATING AND REPORTING ADVERTISING EXPOSURES

(76) Inventors: Michael Carmi, Herzliya (IL); Dubi Sandmann, Herzliya (IL)

Correspondence Address: FOLEY & LARDNER LLP, 150 EAST GILMAN STREET, P.O. BOX 1497, MADISON, WI, 53701-1497, US

(21) Appl. No.: 11/758,237

(22) Filed: Jun. 5, 2007

Related U.S. Application Data
(60) Provisional application No. 60/837,942, filed on Aug. 16, 2006.

(51) Int. Cl. H04N 7/10

(52) U.S. Cl. 725/32

(57) ABSTRACT

A method of and a device for identifying an exposure to an advertisement are provided. An advertisement stream is received from a first device at a third device. A media stream is received from a second device at the third device. The received advertisement stream is presented with the received media stream at the third device using media player application. Timing information associated with presentation of the received advertisement stream using the media player application is captured at the third device. After completion of the presentation of the received advertisement stream, a report is sent from the third device to a fourth device. The report includes the captured timing information.

### CROSS-REFERENCE TO RELATED APPLICATIONS

This application claims the benefit of U.S. Provisional Patent Application Ser. No. 60/837,942 that was filed Aug. 16, 2006, the disclosure of which is incorporated by reference in its entirety.

### FIELD

The field of the disclosure relates generally to streaming media over the internet, media players and systems for billing streamed content. More specifically, the disclosure relates to the presentation of primary streamed media content with a secondary streamed content, such as an advertisement, and to the reporting of secondary content such as advertisement exposures based on monitoring of the media player for presentation of the secondary content such as advertisement.

### BACKGROUND

Advertisements included in video streams sent over the Internet have a unique advantage over advertising presented by a television. Such advertisements can be targeted to specific viewers. One problem associated with such advertisement (ad) is accurate metering of the number and duration of advertisement exposures. Current metering systems rely on cookies that are added to the media in which the ad is placed. A cookie is a very small text stream inserted on a user's computer by a Web server and is unique to the browser installed at the user's computer. Cookies are often used by Web servers to identify users and to authenticate, track, and maintain specific information about users. First-party cookies are sent to and stored on the user's computer by a website that has been visited by the user. Third-party cookies are sent to and stored on the user's computer by a Web site having a domain different than the website visited by the user. For example, a third-party cookie may be sent from an advertising server that delivered an ad to the user's computer or may be a third-party tool used to measure websites visited by the user.

To bill the advertiser correctly, the cookies should report to a server whether an ad was delivered and exposed to a user's computer. Users, however, may remove cookies from their computers, for example, as part of a disk clean-up process. Because the user removed the cookie from their computer, the advertisement server may deposit another cookie on the user's computer potentially leading to an inflated estimate of the unique users who have received the advertisement. Such inflated estimates result in overbilling and eventually may cause advertisers to stop advertisement campaigns supported by unreliable content publishers. Thus, what is needed is a method and a system for reliably calculating and reporting advertisement exposures.

### SUMMARY

A media management application is provided in accordance with an exemplary embodiment. The media management application ensures that only valid exposures to ads are reported to a server that determines bills based on exposure to ads. The provided media management application is integrated as part of a media player to overcome the current problems of reporting advertisement exposures using cookies.

In an exemplary embodiment, a device for identifying an exposure to an advertisement is provided. The device includes, but is not limited to, a communication interface, a computer-readable medium having computer-readable instructions therein, and a processor. The communication interface receives an advertisement stream and a media stream. The processor is coupled to the communication interface and to the computer-readable medium and is configured to execute the instructions. The instructions are programmed to present the received advertisement stream with the received media stream using media player application; to capture timing information associated with presentation of the received advertisement stream using the media player application; and, after completion of the presentation of the received advertisement stream, to send a report to a second device. The report includes the captured timing information.

In another exemplary embodiment, a method of identifying an exposure to an advertisement is provided. An advertisement stream is received from a first device at a third device. A media stream is received from a second device at the third device. The received advertisement stream is presented with the received media stream at the third device using media player application. Timing information associated with presentation of the received advertisement stream using the media player application is captured at the third device. After completion of the presentation of the received advertisement stream, a report is sent from the third device to a fourth device. The report includes the captured timing information.

In yet another exemplary embodiment, computer-readable instructions are provided that, upon execution by a processor, cause the processor to implement the operations of the method of identifying an exposure to an advertisement.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals denote like elements.

FIG. 1 depicts a block diagram of an advertisement processing system in accordance with an exemplary embodiment.

FIG. 2 depicts a block diagram of a device which controls selection of an advertisement for presentation at a user device of the advertisement system of FIG. 1 in accordance with an exemplary embodiment.

FIG. 3 depicts a block diagram of the user device of the advertisement system of FIG. 1 in accordance with an exemplary embodiment.

FIG. 4 depicts a flow diagram illustrating exemplary operations performed in monitoring presentation of an advertisement during presentation of a media stream in accordance with an exemplary embodiment.

FIG. 5 depicts a flow diagram illustrating exemplary operations performed in selecting an advertisement for presentation with a media stream and billing a customer for an exposure time to the presented ad in accordance with an exemplary embodiment.

### DETAILED DESCRIPTION

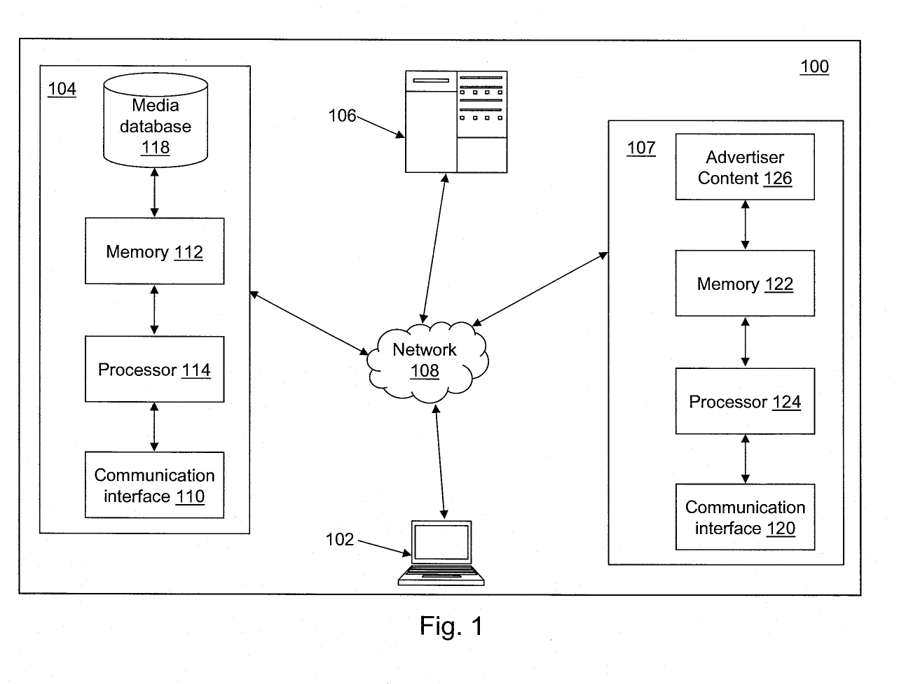

With reference to FIG. 1, a block diagram of an advertisement processing system 100 is shown in accordance with an exemplary embodiment. Advertisement processing system 100 may include a user device 102, a media stream source device 104, an advertisement controller device 106, and an advertiser device 107. User device 102, media stream source device 104, advertisement controller device 106, and advertiser device 107 each may be any type of computing device including computers of any form factor such as a laptop, a desktop, a server, etc., an integrated messaging device, a personal digital assistant, a cellular telephone, an iPod, etc. User device 102, media stream source device 104, advertisement controller device 106, and advertiser device 107 may interact using a network 108 such as a local area network (LAN), a wide area network (WAN), a cellular network, the Internet, etc. In an alternative embodiment, user device 102, media stream source device 104, advertisement controller device 106, and/or advertiser device 107 may be connected directly. For example, media stream source device 104 may connect to advertisement controller device 106 using a cable for transmitting information between media stream source device 104 and advertisement controller device 106.

A computing device may act as a Web server providing information or data organized in the form of websites accessible over a network. A website may comprise multiple web pages that display a specific set of information and may contain hyperlinks to other web pages with related or additional information. Each web page is identified by a Uniform Resource Locator (URL) that includes the location or address of the computing device that contains the resource to be accessed in addition to the location of the resource on that computing device. The type of file or resource depends on the Internet application protocol. For example, the Hypertext Transfer Protocol (HTTP) describes a web page to be accessed with a browser application. The file accessed may be a simple text file, an image file, an audio file, a video file, an executable, a common gateway interface application, a Java applet, an active server page, or any other type of file supported by HTTP. In an exemplary embodiment, media stream source device 104, advertisement controller device 106, and/or an advertiser device 107 are Web servers. In another exemplary embodiment, media stream source device 104, advertisement controller device 106, and/or an advertiser device 107 are peers in a peer-to-peer network as known to those skilled in the art. In an exemplary embodiment, media stream source device 104, advertisement controller device 106, and/or an advertiser device 107 are the same device.

Media stream source device 104 may include a communication interface 110, a memory 112, a processor 114, and a media database 118. Different and additional components may be incorporated into media stream source device 104. For example, media stream source device 104 may include a display or an input interface to facilitate user interaction with media stream source device 104. Components of media stream source device 104 may be positioned in a single location, a single facility, and/or may be remote from one another. For example, the plurality of media streams may be located at different computing devices accessible directly or through a network.

Media stream source device 104 may include a plurality of media files stored in media database 118. Media database 118 may be organized in any format. Media database 118 may include multiple databases to improve data management and access. The multiple databases may be organized into tiers. Additionally, media database 118 may include a file system including a plurality of media files. The media file includes electronic data associated with the presentation of information to a user using various media such as video including a video weblog broadcast, audio, text, graphics, maps, animations, etc. to a user. Additionally, a hyperlink to any other digital source including a web page, other digital media such as video, audio, text, graphics, maps, animations, really simple syndication (RSS) feeds, etc. can be included in a media file of the plurality of media files. Each media file is generally associated with a type of media player capable of interpreting the electronic data to present the desired content to a user. Thus, each media file of the plurality of media files may have a variety of formats as known to those skilled in the art. Additionally, media stream source device 104 may aggregate and transmit live media streams from other digital media sources such as video and audio encoders, and other live sources as known to those skilled in the art. Media consumption methods may include all conventions such as VOD (video on demand), program streams, and live streams.

Communication interface 110 provides an interface for receiving and transmitting data between devices using various protocols, transmission technologies, and media as known to those skilled in the art. The communication interface may support communication using various transmission media that may be wired or wireless. Media stream source device 104 may have one or more communication interfaces that use the same or different protocols, transmission technologies, and media.

Memory 112 is an electronic holding place or storage for information so that the information can be accessed by processor 114 as known to those skilled in the art. Media stream source device 104 may have one or more memories that use the same or a different memory technology. Memory technologies include, but are not limited to, any type of random access memory (RAM), any type of read only memory (ROM), any type of flash memory, etc. Media stream source device 104 also may have one or more drives that support the loading of a memory media such as a compact disk (CD) or digital video disk (DVD) or ports that support connectivity with memory media such as flash drives.

Processor 114 executes instructions as known to those skilled in the art. The instructions may be carried out by a special purpose computer, logic circuits, or hardware circuits. Thus, processor 114 may be implemented in hardware, firmware, software, or any combination of these methods. The term “execution” is the process of running an application or the carrying out of the operation called for by an instruction. The instructions may be written using one or more programming language, scripting language, assembly language, etc. Processor 114 executes an instruction, meaning that it performs the operations called for by that instruction. Processor 114 operably couples with communication interface 110 and with memory 112 to receive, to send, and to process information. Processor 114 may retrieve a set of instructions from a permanent memory device and copy the instructions in an executable form to a temporary memory device that is generally some form of RAM. Media stream source device 104 may include a plurality of processors that use the same or a different processing technology.

Advertiser device 107 may include a communication interface 120, a memory 122, a processor 124, and advertiser content 126. Different and additional components may be incorporated into advertiser device 107. For example, advertiser device 107 may include a display or an input interface to facilitate user interaction with advertiser device 107. Components of advertiser device 107 may be positioned in a single location, a single facility, and/or may be remote from one another.

Advertiser content 126 may include electronic data associated with the presentation of information to a user such as various media including video, audio, text, graphics, a hyperlink to any other digital source including a web page, video, audio, text, graphics, RSS feeds, etc.

Communication interface 120 provides an interface for receiving and transmitting data between devices using various protocols, transmission technologies, and media as known to those skilled in the art. Advertiser device 107 may have one or more communication interfaces that use the same or different protocols, transmission technologies, and media.

Memory 122 is an electronic holding place or storage for information so that the information can be accessed by processor 124 as known to those skilled in the art. Advertiser device 107 may have one or more memories that use the same or a different memory technology. Advertiser device 107 also may have one or more drives that support the loading of a memory media such as a CD or DVD or ports that support connectivity with memory media such as flash drives.

Processor 124 executes instructions as known to those skilled in the art. Processor 124 may be implemented in hardware, firmware, software, or any combination of these methods. Processor 124 executes an instruction, meaning that it performs the operations called for by that instruction. Processor 124 operably couples with communication interface 120 and with memory 122 to receive, to send, and to process information. Processor 124 may retrieve a set of instructions from a permanent memory device and copy the instructions in an executable form to a temporary memory device that is generally some form of RAM. Advertiser device 107 may include a plurality of processors that use the same or a different processing technology.

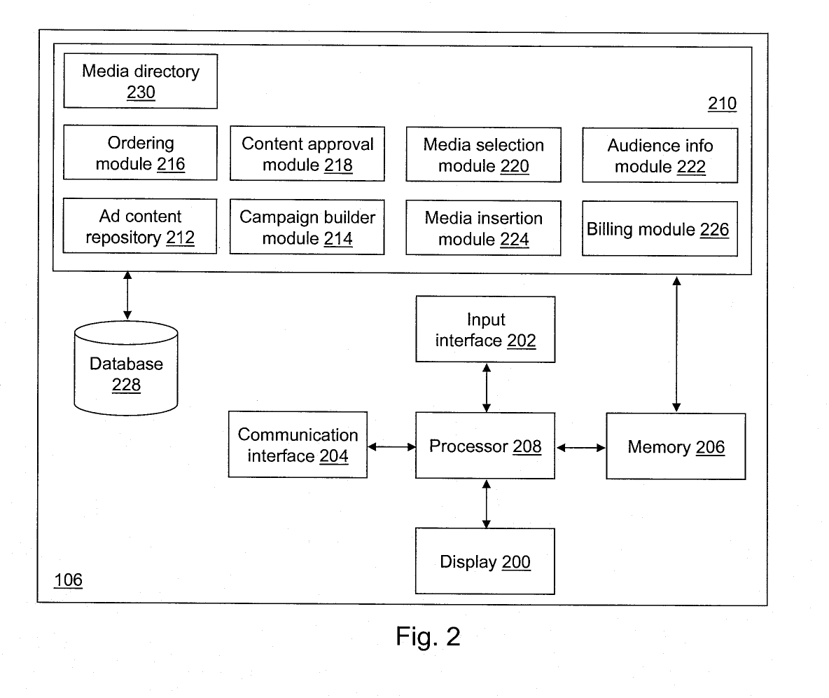

With reference to FIG. 2, advertisement controller device 106 may include a display 200, an input interface 202, a communication interface 204, a memory 206, a processor 208, an advertisement control application 210, and a database 228. Different and additional components may be incorporated into advertisement controller device 106. For example, advertisement controller device 106 may include speakers for presentation of audio media content. Display 200 presents information to a user of advertisement controller device 106 as known to those skilled in the art. For example, display 200 may be a thin film transistor display, a light emitting diode display, a liquid crystal display, or any of a variety of different displays known to those skilled in the art now or in the future.

Input interface 202 provides an interface for receiving information from the user for entry into advertisement controller device 106 as known to those skilled in the art. Input interface 202 may use various input technologies including, but not limited to, a keyboard, a pen and touch screen, a mouse, a track ball, a touch screen, a keypad, one or more buttons, etc. to allow the user to enter information into advertisement controller device 106 or to make selections presented in a user interface displayed on display 200. Input interface 202 may provide both an input and an output interface. For example, a touch screen both allows user input and presents output to the user.

Communication interface 204 provides an interface for receiving and transmitting data between devices using various protocols, transmission technologies, and media as known to those skilled in the art. Advertisement controller device 106 may have one or more communication interfaces that use the same or different protocols, transmission technologies, and media.

Memory 206 is an electronic holding place or storage for information so that the information can be accessed by processor 208 as known to those skilled in the art. Advertisement controller device 106 may have one or more memories that use the same or a different memory technology. Advertisement controller device 106 also may have one or more drives that support the loading of a memory media such as a CD or DVD or ports that support connectivity with memory media such as flash drives.

Processor 208 executes instructions as known to those skilled in the art. Thus, processor 208 may be implemented in hardware, firmware, software, or any combination of these methods. Processor 208 executes an instruction, meaning that it performs the operations called for by that instruction. Processor 208 operably couples with display 200, with input interface 202, with communication interface 204, and with memory 206 to receive, to send, and to process information. Processor 208 may retrieve a set of instructions from a permanent memory device and copy the instructions in an executable form to a temporary memory device that is generally some form of RAM. Advertisement controller device 106 may include a plurality of processors that use the same or a different processing technology.

Advertisement control application 210 performs operations associated with selection of advertisements presented to a user at user device 102 and a determination of billing an advertiser based on presentation of selected advertisements at user device 102. The operations may be implemented using hardware, firmware, software, or any combination of these methods. With reference to the exemplary embodiment of FIG. 2, advertisement control application 210 is implemented in software stored in memory 206 and accessible by processor 208 for execution of the instructions that embody the operations of advertisement control application 210. Advertisement control application 210 may be written using one or more programming languages, assembly languages, scripting languages, etc.

Advertisement control application 210 may include a plurality of modules that may be fully or partially integrated or execute independently. In an exemplary embodiment, the plurality of modules include an ad content repository 212, a campaign builder module 214, an ordering module 216, a content approval module 218, a media selection module 220, an audience information module 222, a media insertion module 224, a billing module 226, and a media directory 230. Ad content repository 212 may include content information associated with a plurality of ad files which may be stored in database 228. Database 228 may be organized in any format and may include multiple databases to improve data management and access. Database 228 may include a file system including a plurality of ad files. The ad file includes electronic data associated with the presentation of ads to a user in the form of various media such as video, audio, text, graphics, etc. The electronic data further may include a hyperlink to any other digital source including a web page, other digital media, audio material, graphics, textual data, digital streams, geographic information system data, RSS feeds, etc. Each ad file is generally associated with a type of media player capable of interpreting the electronic data to present the desired content to a user. Thus, each ad file of the plurality of ad files may have a variety of formats as known to those skilled in the art.

Media directory 230 is created by content and media providers who enter relevant data regarding the content and media, for example, into appropriate tables in media directory 230. The relevant data may include a media type (i.e., video or audio), a transmission mode (video-on demand or live), a content genre (family, adult only, sports, etc.), and terms and conditions associated with accepting an ad.

An advertiser defines a budget, a target audience, a desired exposure, etc. Campaign builder module 214 provides media types and possible providers and titles from media directory 230. Campaign builder module 214 recommends possible media mix alternatives. The advertiser selects the preferred alternative or plans a new campaign. Information associated with the ads is transferred into ad content repository 212 and the ads are transferred into database 228.

After matching the desired media with an ad, and receiving ad approval from content approval module 218, the advertiser places an order received by ordering module 216. Ordering module 216 issues the order to media insertion module 224 to have the ad ready to be transmitted to an audience of users at one or more user devices.

Content approval module 218 receives the ad content from ad content repository 212. The ad content is viewed by a user of media stream source device 104 who, according to the terms and conditions specified by the content provider in media directory 230, either approves the ad content or rejects it. The approval or rejection is transmitted to media selection module 220 to enable the transmission of the ad content to ordering module 216 and to media insertion module 224. An ad may be approved by only a subset of media providers of one or more media stream source devices. As a result, the ad may only be made available to the subset approving the ad.

Media selection module 220 checks the correlation of proposed media, as received from media directory 230, to the proposed ads. When a match occurs, media selection module 220 submits the ad content to content approval module 218 and waits for approval either by the media provider or another approval body accepted by the media provider, such as a content approval service. After receiving the approval, media selection module 220 places the ad in ordering module 216.

Audience information module 222 receives an internet protocol (IP) address, a media that a user is requesting, a time the user connected to media stream source device 104, viewing characteristics that matched the ad insertion criteria, and other data that the audience (user at user device 102) may provide such as the browser and operating system language of user device 102. The audience information is transmitted to the appropriate modules of the plurality of modules of advertisement control application 210 according to the type of data. The requested media and the IP address are transmitted to media stream source device 104 and to media insertion module 224 to enable the transmission of the correct ad to the user at the correct time according to the criteria specified in campaign builder module 214.

Timing information associated with the user's viewing of the ad, and other information specific to the advertisement, such as ad name, and positive confirmation of the presentation of the advertisement at display 300 of user device 102 may be transmitted from user device 102 to advertisement controller device 106 and stored in database 228 for the creation of rating and billing data. In an exemplary embodiment, positive confirmation of the presentation of the advertisement at display 300 of user device 102 is only transmitted from user device 102 to advertisement controller device 106 when the user views the entire advertisement as indicated using start and stop signals. The rating and viewing data are transmitted to billing module 226 to provide the correct billing. The viewing period and other data that may be gathered from the user at user device 102 may be transmitted to advertiser device 107 to be used as marketing information.

Media insertion module 224 includes a table describing conditions for matching ads with content, a targeted audience, available media channels, insertion timing and duration, media, etc. The table may be created using the information received from media directory 230, media selection module 220, and/or ordering module 216. Media insertion module 224 determines if a user matching the criteria entered by the advertiser in campaign builder module 214 is present and ready to receive ads. When such a match between content, media, audience (user), and ad is identified, media insertion module 224 transmits the ad directly to the indicated user device 102.

Billing module 226 may receive pricing information from media directory 230 and actual activities (connection to specific media, actual rating, and confirmation of advertisement presentation) from database 228 and an indication of interactive communication between a user and advertiser device 107. Billing module 226 calculates the payment due from the advertiser and a commission due to the operator of advertisement controller device 106. The billing data may be transmitted as a call detail record to an external billing system

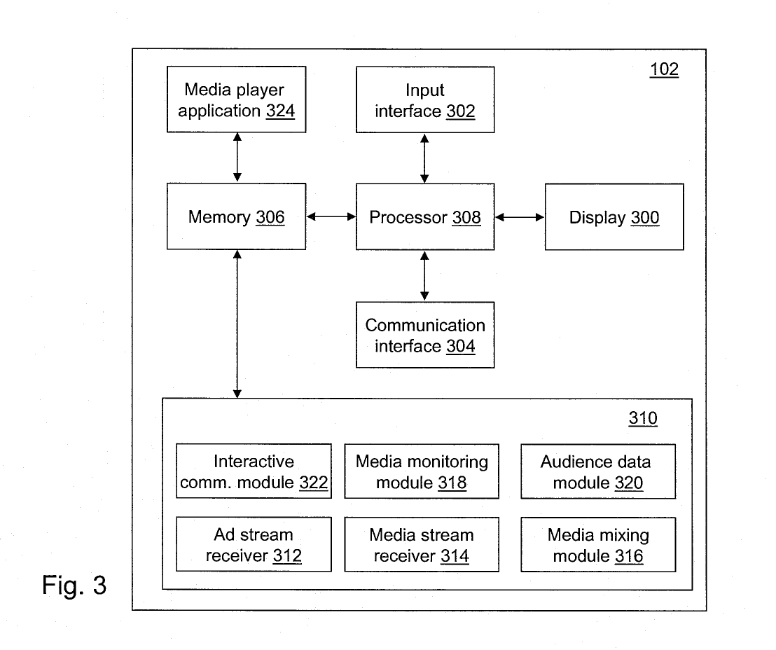

With reference to FIG. 3, user device 102 may include a display 300, an input interface 302, a communication interface 304, a memory 306, a processor 308, a media management application 310, and a media player application 324. Different and additional components may be incorporated into user device 102. For example, user device 102 may include speakers for presentation of audio media content. Display 300 presents information to a user of user device 102 as known to those skilled in the art. For example, display 300 may be a thin film transistor display, a light emitting diode display, a liquid crystal display, or any of a variety of different displays known to those skilled in the art now or in the future.

Input interface 302 provides an interface for receiving information from the user for entry into user device 102 as known to those skilled in the art. Input interface 302 may use various input technologies including, but not limited to, a keyboard, a pen and touch screen, a mouse, a track ball, a touch screen, a keypad, one or more buttons, etc. to allow the user to enter information into user device 102 or to make selections presented in a user interface displayed on display 300. Input interface 302 may provide both an input and an output interface.

Communication interface 304 provides an interface for receiving and transmitting data between devices using various protocols, transmission technologies, and media as known to those skilled in the art. User device 102 may have one or more communication interfaces that use the same or different protocols, transmission technologies, and media.

Memory 306 is an electronic holding place or storage for information so that the information can be accessed by processor 308 as known to those skilled in the art. User device 102 may have one or more memories that use the same or a different memory technology. User device 102 also may have one or more drives that support the loading of a memory media such as a CD or DVD or ports that support connectivity with memory media such as flash drives.

Processor 308 executes instructions as known to those skilled in the art. Processor 308 may be implemented in hardware, firmware, software, or any combination of these methods. Processor 308 executes an instruction, meaning that it performs the operations called for by that instruction. Processor 308 operably couples with display 300, with input interface 302, with communication interface 304, and with memory 306 to receive, to send, and to process information. Processor 308 may retrieve a set of instructions from a permanent memory device and copy the instructions in an executable form to a temporary memory device that is generally some form of RAM. User device 102 may include a plurality of processors that use the same or a different processing technology.

Media player application 324 performs operations associated with presentation of media to a user. The operations may be implemented using hardware, firmware, software, or any combination of these methods. With reference to the exemplary embodiment of FIG. 3, media player application 324 is implemented in software stored in memory 306 and accessible by processor 308 for execution of the instructions that embody the operations of media player application 324. Media player application 324 may be written using one or more programming languages, assembly languages, scripting languages, etc.

Media management application 310 performs operations associated with the presentation of content to be presented with a media stream to the user of user device 102. Media management application 310 manages communication between user device 102, which may include a set-top box, and media stream source device 104, advertisement controller device 106, and advertiser device 107 and transmits a media stream and an ad stream, through media player application 324 to display 300. The media stream may be transmitted based on a live broadcast stream or an on-demand stream. The operations may be implemented using hardware, firmware, software, or any combination of these methods. With reference to the exemplary embodiment of FIG. 3, media management application 310 is implemented in software stored in memory 306 and accessible by processor 308 for execution of the instructions that embody the operations of media management application 310. Media management application 310 may be written using one or more programming languages, assembly languages, scripting languages, etc. Media management application 310 may integrate with or otherwise interact with media player application 324.

Media management application 310 may include a plurality of modules that may be fully or partially integrated or execute independently. In an exemplary embodiment, the plurality of modules include an ad stream receiver 312, a media stream receiver 314, a media mixing module 316, a media monitoring module 318, an audience data module 320, and an interactive communication module 322. Ad stream receiver 312 receives an ad stream from media insertion module 224 of advertisement controller device 106. Media stream receiver 314 receives a media stream from media stream source device 104. Media mixing module 316 receives both the ad stream from ad stream receiver 312 and the media stream from media stream receiver 314. If only a media stream is received, media mixing module 316 transmits the media stream directly into media player application 324. When media mixing module 316 receives both an ad stream and a media stream, media mixing module 316 may present both streams to the display as picture-in-picture in a manner known to those skilled in the art, may mix them into one stream, or may switch between the media stream and the ad stream according to instructions received with the ad stream received from media insertion module 224. The instructions may contain data about the location of the ad stream within the media content, the size of the ad on display 300, the timing and duration of the ad exposure, etc. For example, the instructions may be included in a header of the received ad stream. In another exemplary embodiment, the instructions may be included in a separate file sent to user device 102.

Media monitoring module 318 is triggered on by a connection to the ad stream and the actual presentation of the ad stream to the display 300. Media monitoring module 318 is triggered off by either a disconnection from the ad stream, a disconnection to display 300 while the advertisement is presented, or by ending of the ad stream, as indicated by receiving a control byte signal located in a trailer of the ad stream. In an exemplary embodiment, media monitoring module 318 only sends an exposure confirmation to billing module 226 when media monitoring module 318 turns off as a result of ending of the ad stream. Billing module 226 uses the exposure confirmation to bill the advertiser for the exposure. Media monitoring module 318 may also calculate a time duration, a start time, and/or a stop time that the user of user device 102 is connected to the ad stream. For example, media monitoring module 318 may capture a start signal and an end signal of the ad stream that include a start control byte and an end control byte, respectively. Media monitoring module 318 transmits the timing information to billing module 226 of advertisement controller device 106. Billing module 226 also may calculate whether the user was exposed to the content and ad for a sufficient time period to bill the advertiser for the exposure.

Media monitoring module 318 tracks each ad from the moment it is delivered to user device 102 until it is presented to the user using display 300. Media monitoring module 318 treats each ad separately. If a screen-saver starts or the user minimizes the window of media player application 324 while a commercial is running, media monitoring module 318 switches itself to a “pause” status to indicate that the user is not viewing the ad. Media monitoring module 318 receives an indicator of the screen-saver start from an operating system of user device 102. Media monitoring module 318 receives an indicator of the window minimization from media player application 324. Media monitoring module 318 further receives an indication that a user is skipping a commercial by forwarding the play of the media using media player application 324. Media monitoring module 318 recognizes events indicating that the user is not viewing the advertisement to correctly calculate the timing information associated with the user's exposure to the ad stream.

When presentation of the ad is stopped, the exposure report is sent to advertisement controller device 106. If an ad is presented more than once, for example as a result of seeking backward, the exposure report is sent only after the first exposure. If media monitoring module 318 fails to send the exposure report at the end of the presentation of the ad stream, media monitoring module 318 stores the report in a stream accessible by memory 306 of user device 102. Media monitoring module 318 sends the exposure report the next time the user operates media player application 324 at user device 102.

Audience data module 320 contains data that the user of user device 102 provides to audience information module 222 of advertisement controller device 106. For example, the data may contain the operating system and browser language of user device 102, the user age, gender, and other data that by the user's consent may be gathered and presented to advertisers.

Interactive communication module 322 creates an advertiser selection area, or overlay, on display 300 which the user of user device 102 may select using input interface 302. The selection may hyperlink the user directly to advertiser device 107. The hyperlink may be to the advertiser's website or other interactive system provided by advertiser device 107. Interactive communication module 322 may send an indication of the selection by the user to billing module 226 of advertisement controller device 106 to provide for billing according to the price for an interactive communication that results from the ad's exposure.

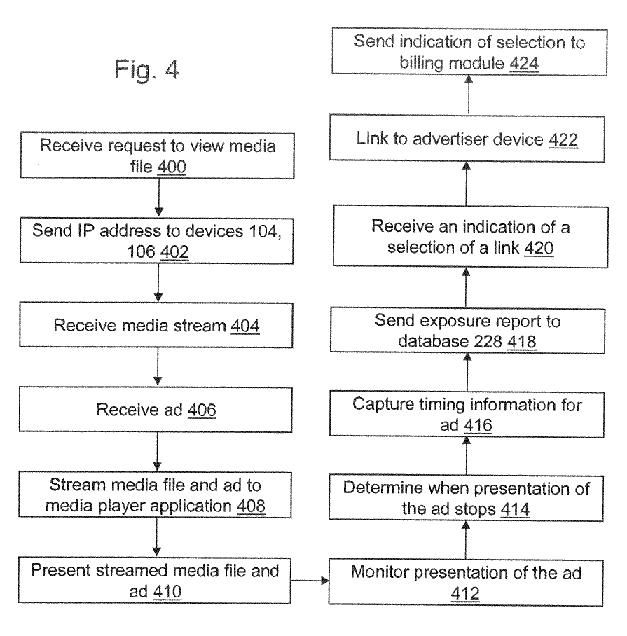

With reference to FIG. 4, exemplary operations associated with media management application 310 of FIG. 3 are described. Additional, fewer, or different operations may be performed, depending on the embodiment. The order of presentation of the operations is not intended to be limiting. In an operation 400, media management application 310 receives a request from the user of user device 102 to view a media stream. For example, the user may select a media stream by entering or selecting a link to media stream source device 104 using a variety of methods known to those skilled in the art.

In an operation 402, the IP address of the user device 102 is sent to media stream source device 104 and/or the audience information module 222 of advertisement controller device 106 to enable the targeted ad insertion to the user while viewing the selected media stream. In an operation 404, the selected media stream is received by media stream receiver 314. In an operation 406, an ad stream selected by media insertion module 224 of advertisement controller device 106 is received by ad stream receiver 312. The ad stream is selected based on information provided by audience data module 320 of user device 102 to media insertion module 224 of advertisement controller device 106.

In an operation 408, the received media stream and the received ad stream are streamed from media mixing module 316 to media player application 324. In an operation 410, media player application 324 presents the streamed media stream and ad stream on display 300. For example, the user may select a play button or the streamed media stream and ad stream may automatically start playing as they are received at user device 102.

In an operation 412, media monitoring module 318 monitors presentation of the ad stream. Media monitoring module 318 recognizes the end of the ad stream, as indicated by the control byte in the trailer of the stream, to send an exposure confirmation to billing module 226. Events indicating that the user is not viewing the advertisement are identified to prevent erroneous confirmation and to correctly calculate the timing information associated with the user's exposure to the ad stream. In an operation 414, media monitoring module determines when presentation of the ad stream stops. When presentation of the ad stream stops, media monitoring module 318 makes sure that the control byte signaling the ad stream end is received and captures the timing information in an operation 416. Media monitoring module sends an exposure report including the exposure confirmation and/or timing information to database 228 of advertisement controller device 106 in an operation 418.

In an operation 420, media monitoring module determines whether or not the user selects the advertiser selection area. If the user selects the advertiser selection area, processing continues at an operation 422. If the user does not select the advertiser selection area, processing continues at operation 412. In operation 422, interactive communication module 322 links the user directly to advertiser device 107 or another link specified by the advertiser. In an operation 424, interactive communication module 322 sends an indication of the selection by the user to billing module 226 of advertisement controller device 106 in the exposure report or in another report.

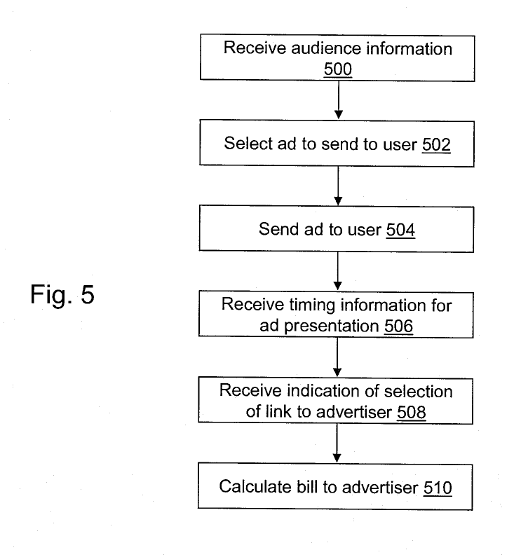

With reference to FIG. 5, exemplary operations associated with advertisement control application 210 of FIG. 2 are described. Additional, fewer, or different operations may be performed, depending on the embodiment. The order of presentation of the operations is not intended to be limiting. In an operation 500, audience information module 222 of advertisement control application 210 receives audience information from the user of user device 102. The audience information module may include the IP address of user device 102, the media that the user is requesting, the time the user connected to media stream source device 104 to request the media, other data that the audience (user at user device 102) may provide, etc. The audience information may be transmitted to the appropriate modules of the plurality of modules of advertisement control application 210. For example, the requested media and the IP address may be transmitted to media insertion module 224. In an operation 502, media insertion module 224 selects the ad stream to send to the user. For example, media insertion module 224 may include a table describing conditions for matching ads with content, a targeted audience, available media channels, insertion timing and duration, and media types. In an operation 504, media insertion module 224 sends the selected ad stream to the user at user device 102 at the correct time according to the criteria specified in campaign builder module 214.

In an operation 506, timing information associated with the user's viewing of the ad stream is received from user device 102. The timing information may be stored in database 228 for the creation of rating and billing data. The rating and viewing data also may be transmitted to billing module 226 to calculate the correct billing to an advertiser in an operation 510. Billing module 226 may receive pricing information from media directory 230 and actual activities (connection to specific media, actual rating) from database 228. In an operation 508, an indication of selection of a hyperlink to an advertiser by the user at user device 102 is received. Billing module 226 may include the indication of interactive communication between a user and advertiser device 107 in the billing calculation of operation 510.

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more.”

The exemplary embodiments may be implemented as a method, apparatus, or article of manufacture using standard programming and/or engineering techniques to produce software, firmware, hardware, or any combination thereof to control a computer to implement the disclosed embodiments. The term “computer readable medium” can include, but is not limited to, magnetic storage devices (e.g., hard disk, floppy disk, magnetic strips, . . . ), optical disks (e.g., compact disk (CD), digital versatile disk (DVD), . . . ), smart cards, flash memory devices, etc. Additionally, it should be appreciated that a carrier wave can be employed to carry computer-readable media such as those used in transmitting and receiving electronic mail or in accessing a network such as the Internet or a local area network (LAN). The network access may be wired or wireless.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally, the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A device for identifying an exposure to an advertisement, the device comprising:
a communication interface, the communication interface receiving a media stream and an advertisement stream;
a computer-readable medium having computer-readable instructions stored therein which are programmed to
present the received advertisement stream with the received media stream using a media player application;
capture timing information associated with presentation of the received advertisement stream using the media player application; and
after completion of the presentation of the received advertisement stream, send a report to a second device, the report including the captured timing information; and
a processor, the processor coupled to the communication interface and to the computer-readable medium and configured to execute the instructions.

2. A computer-readable medium including computer-readable instructions that, upon execution by a processor, cause the processor to identify an exposure to an advertisement, the instructions configured to cause a computing device to:
receive an advertisement stream from a first device;
receive a media stream from a second device;
present the received advertisement stream with the received media stream using media player application;
capture timing information associated with presentation of the received advertisement stream using the media player application; and
after completion of the presentation of the received advertisement stream, send a report to a third device, the report including the captured timing information.

3. A method of identifying an exposure to an advertisement, the method comprising:
receiving an advertisement stream from a first device at a third device;
receiving a media stream from a second device at the third device;
presenting the received advertisement stream with the received media stream at the third device using media player application;
capturing timing information associated with presentation of the received advertisement stream using the media player application at the third device; and
after completion of the presentation of the received advertisement stream, sending a report from the third device to a fourth device, the report including the captured timing information.

4. The method of claim 3, wherein the received advertisement stream and the received media stream are presented in a window created by the media player application at the third device.

5. The method of claim 4, further comprising monitoring the presentation of the received advertisement stream with the received media stream at the third device.

6. The method of claim 5, wherein monitoring the presentation comprises receiving an event indicating that a user is not viewing the presentation at the third device.

7. The method of claim 6, wherein the event is minimizing the window created by the media player application.

8. The method of claim 6, wherein the event is forwarding the presentation of the received advertisement stream using the window created by the media player application.

9. The method of claim 6, wherein the event is rewinding the presentation of the received advertisement stream using the window created by the media player application.

10. The method of claim 6, wherein the event is a screen-saver start at the third device.

11. The method of claim 5, wherein monitoring the presentation comprises receiving an indication that a user has selected a hyperlink to an advertiser created in the window.

12. The method of claim 11, wherein the report further includes information indicating selection of the hyperlink to the advertiser.

13. The method of claim 11, further comprising sending a second report from the third device to the fourth device, the second report including information indicating selection of the hyperlink to the advertiser.

14. The method of claim 3, wherein the received media stream includes media selected from the group consisting of video, audio, text, one or more graphic, one or more animation, and one or more hyperlink to one or more digital source.

15. The method of claim 3, wherein the received advertisement stream includes media selected from the group consisting of video, audio, text, one or more graphic, one or more animation, and one or more hyperlink to one or more digital source.

16. The method of claim 16, wherein the one or more digital source includes a web page, video, audio, text, one or more graphic, and a really simple syndication feed.

17. The method of claim 3, wherein the first device and the fourth device are the same device.

18. The method of claim 3, further comprising receiving a request to view the media stream at the third device.

19. The method of claim 19, further comprising sending an internet protocol address and an identifier of the media stream to the first device.

20. The method of claim 3, further comprising capturing a start signal and an end signal of the advertisement stream wherein the report further includes an exposure confirmation.
